(19) United States
(12) Patent Application Publication
(10) Pub. No.: US 2019/0148798 A1
(43) Pub. Date: May 16, 2019

(54) PYROMETALLURGICAL PROCESS FOR RECYCLING OF NIMH BATTERIES

(71) Applicant: Nilar International AB, Täby (SE)

(72) Inventors: Martin HÄGGBLAD SAHLBERG, Uppsala (SE); James LUDICK, Cape Town (ZA)

(73) Assignee: Nilar International AB, Täby (SE)

(21) Appl. No.: 16/304,414

(22) PCT Filed: May 23, 2017
(86) PCT No.: PCT/SE2017/050548

§ 371 Date: Nov. 26, 2018

(30) Foreign Application Priority Data
May 25, 2016 (SE) 1650727-9

(51) Int. Cl. H01M 10/54; C22B 23/02; C22C 1/02; H01M 4/38

(52) U.S. Cl. CPC H01M 10/54; C22B 23/02; H01M 2004/027; H01M 4/385; C22C 1/023

(57) ABSTRACT

The present disclosure concerns a method of producing a nickel-containing hydrogen storage alloy for use in a nickel metal hydride battery, the method comprising the steps: i. Providing a mixed active material comprising used positive electrode active material and used negative electrode active material; ii. Reducing the mixed active material, thereby obtaining a reduced active material; iii. Adding one or more metals to the reduced active material; iv. Remelting the mixture obtained in step iii; thereby obtaining a nickel-containing hydrogen storage alloy. The present disclosure also concerns nickel-containing hydrogen storage alloys obtained by the disclosed method.

### TECHNICAL FIELD

The present disclosure concerns a method of producing nickel-based hydrogen storage alloys for use in nickel metal hydride batteries. The disclosure also relates to hydrogen storage alloys produced by such a method.

### BACKGROUND ART

### Early History of Nickel Metal Hydride Batteries

Nickel Metal Hydride batteries (NiMH) today are an extension of the currently rechargeable Nickel-cadmium battery technology which was developed and researched originally by Battelle-Geneva Research Centre in 1967 [1]. The Nickel metal hydride batteries were originally introduced because of their need for a more non-toxic material base and less expensive option (patent NiMH). With further research and development in the nickel based batteries, Ovonic Battery Co. [1] in 1989 went on to introduce Nickel metal hydride batteries which is said to replace the cadmium based (in the near future) as a safer and environmentally engineered enhanced option and which essentially came as hybrid battery technology to maintain the benefits of the cadmium based and reduce the risks and challenges involved with this option. The NiMH battery consist of rare earth metals in various compositions and a negative electrode which is capable of a reversible electrochemical storage of hydrogen, hence the name [2]. There are many different types of Nickel based batteries each having their own unique properties and applications and most of the research today regarding these (NiMH) batteries are for the storage of hydrogen as an alternative storage option for hydrogen. NiMH batteries are currently being used in hybrid electric vehicles in industry by certain manufacturers (e.g Toyota and Honda) but initially started for some smaller scale applications (portable electronic devices etc), see refs [5] and 29.

As NiMET batteries is a developing field in battery technology further challenges regarding a more stable and environmentally friendly Nickel battery is still a concern for most battery producing companies. Together with the EU legislations and environmentally practices (Battery directive 2006/66/EC and EU Member state national legislation) [5], Nilar has been developing in the past few years industry standard Nickel Metal Hydride batteries which address all or most of these health and safety concerns into their product line which consists of continuously improvements in all stages of the batteries life cycle and to minimize the environmental impact [5]. Recycling rates of spent batteries and production waste from new batteries has come up as an important part of their Research and Development Department to address these issues. Essentially about 99% of the spent battery can be reused into other industries as raw materials, however the challenge lies to meet this percentage of recovery in the already established production line.

### Basic Cell NiMH Electrochemical Mechanism

The positive and negative electrodes are produced by mixing dry powder of the active materials and then compressed under high pressure to produce the electrode sheets [5]. These sheets are then cut in the manufacturing process according to their weight, dimensions and compositions to produce the electrode plates for the cells. The electrolyte used for these NiMH battery units is a solution of potassium hydroxide and lithium hydroxide. The electrolyte in the unit is completely sealed between the electrodes with no free volume. All of the electrolyte is absorbed by the positive and negative electrodes and the separator [5]. The biplates incorporated into the units design is also an important component for sealing each cell together with gaskets. The biplates also provide the electrical contact between the cells and is made of a thin nickel foil [5]. One of the features promoted by the Nilar is the bipolar battery design which in principle relates to a unique electrochemical aging process of the batteries and in turn prolongs the battery service life. This feature is therefore incorporated into the design and manufacturing of the battery and therefore includes special materials and components which form part of the batteries inherent electrochemical properties [5].

### Positive and Negative Electrodes

The positive electrode of the NiMH cell consists of the charge and discharge equation which is represented as follows:

Ni(OH)₂+OH⁻ [symbol] NiOOH+H₂O+e⁻ (1)

With the forward being charged reaction and the reverse being the discharge [2]

The negative electrode of the NiMH cell consists of the charge and discharge equation which is represented as follows:

M+H₂O+e⁻ [symbol] M−H+OH⁻ (2)

With the forward being charged reaction and the reverse being the discharge and M represented as the metal hydride material [2]

The overall reaction will therefore be the addition of the two half reactions:

MH+NiOOH [symbol] M+Ni(OH)₂ (3)

The positive material used in the production of the Nickel Hydride batteries comprises nickel powder whereas the negative material on the other hand comprises AB₅. The two are separated by a separator cloth material so that the two electrodes are not in direct contact with each other. For the purposes of these recycling methods, the separator has to be removed from the material so that it can be treated by the pyro-metallurgical processes which follows.

### Recycling Processes for NiMH Batteries

Currently there are a few recycling processes that are being used to recover materials from spent batteries in industry. These processes are specific to the battery type and chemical composition. Nickel-cadmium batteries and lead based batteries for example are said to have the biggest environmental impact and because of this Nickel-cadmium batteries have been banned by the European governments in 2009 [1]. Lead batteries are also in the process of being banned but a replacement is still needed. Nickel-metal hydride batteries are considered to be semi-toxic and therefore processes are still being improved to make it more environmentally friendly.

Most commonly, recycling processes start with batteries being sorted and characterized by their type and chemical compositions, see ref 20. It is then important to remove the plastics and combustible materials of the outer shells of the batteries by certain dismantling techniques depending on shape and size. Some recycling processes consists of deactivation or discharging of the battery which are especially used for battery systems in electric vehicles [20] and which takes place before the dismantling stage. The bi-polar NiMH battery by Nilar consists of around 12 components which need to be considered during the dismantling stage, see ref [5]. Thereafter the batteries might undergo mechanical/physical processes which are important for obtaining the materials in the correct sizes for further processing or for further sorting stages. These mechanical stages can include, crushing, grinding, milling, sieving, separation (which can include magnetic and non-magnetic techniques). Typically the stages which follow are the hydrometallurgy and pyro-metallurgy. These processes each have their advantages and disadvantages depending on which battery type and raw materials are used to in the recovery steps. Studies have found that most battery types can recover up to 90% of the metallic elements in hydrometallurgy processes and therefore makes it a more preferred method. Pyro-metallurgy processes are less favoured in this regard but are still useful depending on the compositions and are therefore not excluded in some recycling processes. However in this paper the pyro-metallurgy processes are studied as the favourable methods for recovering according to the scope.

### Metal Hydrides for Hydrogen Storage Alloys Development

It is said to believe that the initial development of hydrogen storage alloys started with TiNi and LaNi₅ (Titanium Nickel alloy and La) in the early 1970s [2] and later development went into modification of these materials. Upon more research it was found that these alloy systems were too unstable due to a number of contributing factors (e.g slow discharge, poor kinetics etc) which lead up to these findings. Stanford R. Ovskinsky and his team at the Energy Conversion Devices of Troy, Mich. went on to show that the relatively pure metallic compounds for these applications was a major shortcoming due to one of the factors being the relatively low density of hydrogen storage sites [2]. Further development and research has lead up to more commonly used materials in metal hydride applications which is rare earth-based AB₂, AB₅ and A₂B₇ intermetallic alloy. This material has been extensively studied by looking at its composition, structure, electrochemical properties and performance [7].

### Reduction and Hydrogenation

Due to the good properties of AB₅ alloys for hydrogen storage [23], extensive work has been done on these materials (and other alloy groups) to investigate and improve properties even further for hydrogen as an energy carrier. One of the main examples of AB₅ alloys used in the production of NiMH batteries is the LaNiCoMnAl compound (with specific ratios of the components). This compound has the A (or sometimes La) and B being usually the Ni, Co, Mn, Al elements. The alloy is said to be an AB_{5.2} alloy, slightly different structure compared to that of other NiMH batteries. This is due to Nilars unique performance criteria for their design and which should be as standard when altering the AB₅ alloy. An example of a hydrogenation reaction with the alloy is as follows [23]:

LaNi₅+3.35H₂=LaNi₅H_{6.7} (4)

Recently it has been found [27] that a La_{0.8}Mg_{0.2}Ni_{3.4-x}Co_{0.3}(MnAl)ₓ metal hydride alloy is giving positive results in terms of a large hydrogen storage capacity and better performance data when looking at charging and discharging capacity for NiMH batteries. It was found that the addition of Mg and Al at certain percentages changes the crystal structure [27] and this lead to a very low decrease in discharge capacity with an alloy that contains 5:19 phases (x=0.15) when it was repeated tested by charging and discharging. This is because the degree of expansion and contraction is rather small in the 5:19 phase [27] which was due to the absorption and release of hydrogen in the metal hydride.

### SUMMARY OF THE INVENTION

The object of the invention is to provide a method for effective recycling of battery materials that allows the recycled material to be incorporated into existing battery production streams.

This object is achieved by a method of producing a nickel-containing hydrogen storage alloy for use in a nickel metal hydride battery according to the appended claims.

The method comprises the steps:
i. Providing a mixed active material comprising used positive electrode active material and used negative electrode active material;
ii. Reducing the mixed active material, thereby obtaining a reduced active material;
iii. Adding one or more metals to the reduced active material;
iv. Melting the mixture obtained in step iii; and
v. Cooling the melt, thereby obtaining a nickel-containing hydrogen storage alloy.

The mixed active material may comprise at least 10% by weight of used positive electrode active material, such as at least 20% by weight, or at least 30% by weight. The mixed active material may comprise at least 10% by weight of used negative electrode active material, such as at least 20% by weight, or at least 30% by weight. The mixed active material may comprise at least 50% by weight of used positive electrode active material and used negative electrode active material in total, such as at least 70% by weight, or at least 90% by weight. The mixed active material may essentially consist of or consist of used positive electrode active material and used negative electrode active material.

The used positive electrode active material may comprise nickel oxyhydroxide and the used negative electrode active material may comprise an AB₅ alloy, wherein A is mischmetal, La, Ce or Ti, and B is Ni, Co, Mn or Al. Thus, common electrode active materials from nickel metal-hydride batteries may be recycled.

The nickel-containing hydrogen storage alloy obtained may be AB₅, wherein A is mischmetal, La, Ce or Ti, and B is Ni, Co, Mn or Al. Thus, the alloys obtained can be readily re-used in existing NiMH battery production streams.

The one or more metals added in step iii may be chosen from mischmetal, La, Al, virgin AB₅ alloy, or mixtures thereof. The mischmetal, La, and/or Al may be added in quantities sufficient to recreate the elemental ratio of an AB₅ alloy. Thus, alloys of the same composition as virgin AB₅ alloys may be obtained.

The reduction in step ii. may be performed under a hydrogen atmosphere of about 700 mBar. The reduction may be performed at a temperature of about 200° C. to about 500° C., preferably at about 220° C. to about 280° C., even more preferably from about 240° C. to about 260° C. These conditions avoid the formation of La₂O₃ and/or nickel oxides.

The product of step ii and/or step iii may be stored under inert atmosphere prior to further use. This avoids oxidation of the nickel in the reduced intermediate product and increases the final yield of hydrogen storage alloy.

A step of removing electrode support materials and washing the used positive and negative electrode materials may be performed prior to step i. This avoids the incorporation of any foreign materials or metals in the final hydrogen storage alloy.

Slag may be removed from the melt in step iv. This provides a purer hydrogen storage alloy.

Melting in step iv. May be performed at 900-1100° C., preferably about 1000° C. This provides the appropriate alloy phase.

In step v, the melt may be cooled over at least 10 hours, preferably at least 20 hours. This provides the appropriate phase in high yields.

According to a further aspect of the present invention, a nickel-containing hydrogen storage alloy for use in nickel metal-hydride batteries, obtained by the method described above is provided.

The nickel-containing hydrogen storage alloy may be an AB₅ alloy wherein A is mischmetal, La, Ce or Ti, and B is Ni, Co, Mn or Al, preferably LaNi₅ or MmNi₅. Thus, commonly utilized alloys in NiMH batteries may be obtained.

According to another aspect, a nickel-containing hydrogen storage alloy comprising nickel obtained from used positive electrode active material is provided.

Further aspects, objects and advantages are defined in the detailed description below with reference to the appended drawings.

### BRIEF DESCRIPTION OF THE DRAWINGS

For a fuller understanding of the present invention and further objects and advantages of it, the detailed description set out below should be read together with the accompanying drawings, in which the same reference notations denote similar items in the various diagrams, and in which:

FIG. 1 is a flow diagram illustrating the proposed recycling process for NiMH electrodes.

FIG. 2a is a x-ray diffractogram of an initial negative electrode material.

FIG. 2b is a x-ray diffractogram of an initial mixed electrode material.

FIG. 2c is a x-ray diffractogram of a reduced negative electrode material.

FIG. 2d is a x-ray diffractogram of a reduced mixed electrode material.

FIG. 3a is an XRD pattern for mixed crushed sample after reduction.

FIG. 3b is an XRD pattern for mixed non-crushed sample after reduction.

FIG. 4a is an XRD pattern for negative material after reduction 1 and arc melting.

FIG. 4b is an XRD pattern for mixed material after reduction 1 and arc melting.

FIG. 5a shows a series of XRD patterns obtained by reduction in-situ for mixed material.

FIG. 5b shows the end scan XRD pattern obtained from reduction in-situ for mixed material.

FIG. 6a shows a series of XRD patterns for the reduction of Ni(OH)2 at different temperatures showing the reduction from the orange and pink patterns (bottom) to the blue pattern (top, at 200° C.).

FIG. 6b shows the XRD pattern for Nickel showing an increase in the intensity from 200° C. and taken from the same XRD pattern scan as FIG. 6a.

FIG. 7a shows the XRD pattern for the pure mixed material before reduction.

FIG. 7b shows the XRD pattern for pure mixed material after reduction at 250° C. and 700 mbar pressure under argon environment.

FIG. 8 shows the XRD pattern for reference LaNi5 produced using the arc melting process.

FIG. 9a shows the XRD pattern for the material after reduction showing the La₂Ni₃ phase in red and Ni also present.

FIG. 9b shows the XRD pattern for the material in FIG. 9(a) after heat treatment.

FIG. 10a shows the SEM image of the Heat Treatment sample showing traces of LaNi5 in the centered structure.

FIG. 10b shows the SEM image of the Heat Treatment sample showing the main La2O3 structure.

FIG. 11a shows the XRD pattern for the refined arc melting stage showing only LaNi₅ and slight traces of Nickel.

FIG. 11b shows the XRD pattern for the slag material produced from the arc melting stage mainly showing La₂O₃ with traces of LaNi5.

FIG. 12a shows the XRD pattern end scan for Negative material in-situ reduction showing at 250° C. where the La(OH)3 peak is.

FIG. 12b shows the XRD pattern for negative material showing a zoomed version of FIG. 12a where the decrease in intensity of La(OH)3 is between 250 and 275° C.

FIG. 13 shows the XRD pattern resulting from the reduction of mixed material at 300° C. with vacuum heating at 600° C. method and after arc melting.

FIG. 14 shows the XRD pattern for the mixed material after reduction at 300° C. and vacuum at 600° C.

FIG. 15a shows the XRD pattern for the new reduction of the mixed material before reduction.

FIG. 15b shows the XRD pattern for the new reduction of the mixed material after reduction.

FIG. 16a shows the XRD of the initial mixed material, wherein the reduction stages and arc melting are done under storage of Argon environment.

FIG. 16b shows the mixed material after reduction, wherein the reduction stages and arc melting are done under storage of Argon environment.

### DETAILED DESCRIPTION

Pyro-Metallurgy for NiMH Batteries

In order to look at pyro-metallurgy methods to recycle NiMH batteries, one has to look into the thermodynamic behavior of these elemental components and suitable metal/slag recovery systems, environmental processing, energy balance and feasibility of the intended pyro-metallurgical process.

### Thermodynamic Properties:

Previous reports has suggested that for NiMH batteries [20] the temperature range should be between 1400° C. and 1700° C. depending on the refractory material and composition of rare earth slag and metallic ratios. Retention time and reaction conditions will also be crucial in the process. One of the main techniques used to obtain thermodynamic properties of metal hydride systems [24] is using the equilibrium pressure for hydrogen as a function of temperature and percentage of hydrogen content in the hydride. The system works in such a way that as hydrogen is dissolved in the metal alloy, the equilibrium hydrogen pressure is increased until the solubility is reached [24].

With the addition of more hydrogen, the hydrogen saturated metal (metal phase) is converted to the metal hydride until it reaches above the composition (at the n value) and this leads to an increase in pressure in the system [24]. The increase in temperature affects the system in such a way that homogenous range of the metal hydride phase widens and the solubility of hydrogen in the metal increases [24]. The thermodynamic activities of the solid can therefore be written by the van't Hoff equation:

R ln P_{H2}=(ΔH/T)−ΔS 5

The absorption and desorption of the metal hydride is also important for the percentage hydrogen content in the system. More specifically for the LaNi5 metal hydride the isotherm for its degradation after a number of cycles is what can used to determine what factors can be improved upon in the system (see ref [26]). Based on the phase of the material that is initially present in the system, one has to look at the phase diagram for LaNi5 to understand at what temperatures and compositions the desired phase can be reached. This is important as it can relate to the exact steps taken in the pyro-metallurgy process in order to reach the correct composition of the material, see ref [28].

### Energy Balance:

For example when looking at the HTMR (High Temperature Metal Recovery) process, the energy balance can be done on the system to partially determine the environmental impact and energy consumption [9]. The HTMR process is based on the traditional technique used to recycle rechargeable batteries using the pyro-metallurgical process. The process usually consists of a mechanical shredding stage (could also be milling or size reducing step), a reduction step, smelting and casting. The process will also consist of wet scrubber and filtration stages in between which are also important for environmental reasons [9] and a basic energy balance will be included to see if the process is feasible. The energy of the system will be based on the first law of thermodynamics:

Useful Energyₒᵤₜₚᵤₜ=Energyᵢₙₚᵤₜ−Energyₗₒₛₛ (6) [9]

Due to the smelting and reduction stages contributing most energy, the input and output energy can be done mainly around these. The factors influencing the energy of the system will be, the type of furnace and operating conditions, time of cycle, chemical reaction, slag system (if necessary) and utilities.

### Proposed Process Flow for Recycling

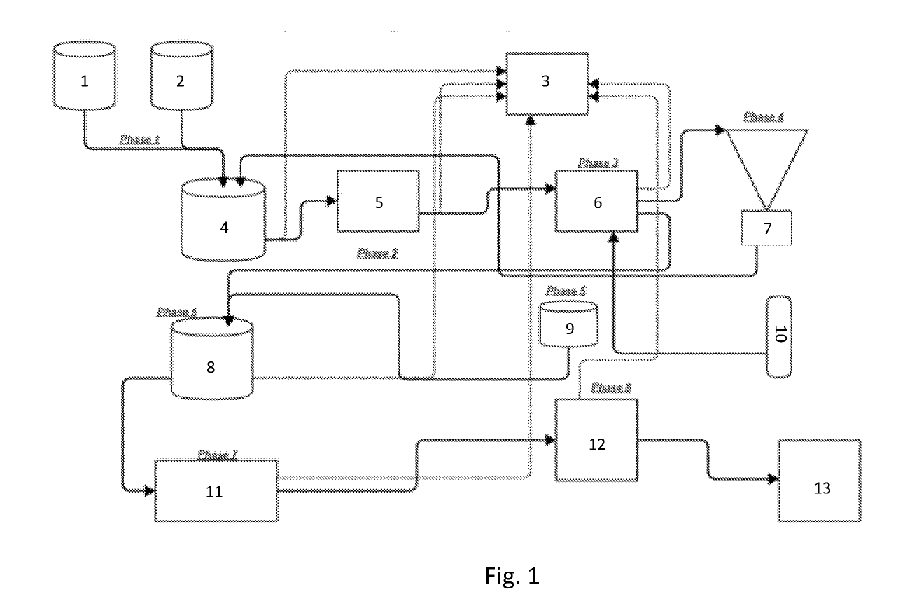

FIG. 1 is a process flow diagram illustrating the proposed recycling process for NiMH electrodes, and wherein the reference signs indicate:
1 Positive Spent Feed
2 Negative spent feed
3 Lab/Quality control
4 Homogenous mixing/blending
5 Washing/Drying Stage
6 Stage reduction
7 Dust recovery system
7 Mixing/Blending Stage
9 Lanthanum feed
10 Hydrogen supply
11 High Temperature Furnace Smelting
12 Electrochemistry Process and Performance Testing
13 Feed to Final Product/Main raw material feed

Table 1 below refers to the phase numbers in FIG. 1 and describes what each phase number represents in the proposed process.

TABLE 1

| Phase | | |
|---|---|---|
| Number | Description | Parameters |
| No 1 | Feed positive and negative | Homogeneous mixing, Correct |
| | spent material, Blending | ratio, weigh feeder |
| | and Mixing | |
| No 2 | Washing and Drying Stage | Washing with water depends |
| | | on initial weight & filter drying |
| No 3 | Stage Reduction | In-situ Reduction with |
| | | Hydrogen Gas, temperature |
| | | 30-600° C., 1 BAR H₂, XRD |
| No 4 | Dust Recovery System | Important to account for any |
| | | loses and re-feed material back |
| | | into the process. Also for safety |
| | | reasons |
| No 5 | Lanthanum Re-feed, Metal | Depends on the quality or the |
| | re-feed | processed material and fed by |
| | | weight and quality |
| No 6 | Blending/Mixing Stage | Important for homogeneous |
| | | mixing of material to obtain |
| | | correct specifications of final |
| | | material, weigh feeder |
| No 7 | High Temperature Furnace | Parameters depends on type of |
| | Smelting | machine/furnace used, |
| | | temperature 1300-2000° C., |
| | | Argon 400 mbar pressure. |
| | | Might also contain a re-feed |
| | | system depending on slag and |
| | | impurities |
| No 8 | Electrochemistry Process | Depends on High Temperature |
| | | parameters, Compositions of |
| | | AB₅, Performance of material |
| | | and Nilar specifications |

### Experimental Methods

The samples collected from Nilar were electrodes from 1 module containing the positive and negative electrodes (mixed) together in water (for safety purposes). Also provided was a single negative electrode from 1 module also in water. The scrim was also included in the mixed sample. The material (both samples, mixed and negative) was removed from the scrim and washed with around 500 ml of water and dried using a standard filter and filter paper.

### Initial Sample Preparation:

The first sample taken was from the negative electrode. A small amount of sample was taken to be analyzed in the XRD. Around 7 g of sample was initially washed to be used for analysis.

The second sample taken was from the mixed electrodes. The same procedure was followed for it.

The samples was then analyzed using XRD.

### X-Ray Diffraction

X ray diffraction is a technique used to identify the phase of a crystalline material and can provide information on the unit cell dimensions [25]. It uses monochromatic X rays generated by a cathode ray tube and is directed to a crystalline sample with constructive interference when the conditions for Bragg's Law is satisfied. The incident ray is related to the diffracted angle and the lattice spacing in the sample and the sample is scanned through a range of 2theta for all possible diffracted directions [25]. The diffracted rays are then detected (by a detector) and processed and counted. A pattern is then created based on the given lattice spacing of the crystalline sample and generated in the program to be analyzed further.

### Parameters:

Initially a quick scan (around 10 min) of the sample was done to identify what can be expected in the sample. The XRD pattern is then compared with the expected elements in the sample with a data based program. Thereafter a job is created to do a longer sample scan running for about 3 hours and angle range from 10° to 90° and angle step of 0.008° per 192 s (pre-programmed settings).

### Sample Preparation:

An important part of obtaining good results is to do proper sample preparation (powder samples). A small amount of sample is taken and placed into grinding crucible. A few drops of ethanol is added and the sample is grinded by hand until it is very fine and slightly wet. The sample is then placed gently on a silica based sample screen with a shiny center (of course the sample holder should be cleaned properly before use with ethanol and dried). The sample is then spread very evenly on the center and excess is removed gently. The sample is then dried under light to remove excess ethanol and thereafter the sample is ready for analysis.

### Vacuum Furnace (MPF)

The furnace used is the vacuum furnace. The aim was to reduce the Nickel Hydroxide in the positive and negative electrode material (the mixed material) to nickel metal and any Lanthanum hydroxide in the initial sample to lanthanum metal (if possible) by heating at 600° C. under a hydrogen gas atmosphere for 4 hours. The pressure is set to 600 mbar inside the chamber and the system is flushed with a unique flushing technique. When the system is at atmospheric pressure (1000 mbar), the glass tube (sample holder) can be removed safely. The sample is placed in a suitable crucible (5-10 g) making sure the crucible is cleaned before. The glass tube is then secured tightly onto the chamber and screws tighten and a safety wire net placed on the glass. The vacuum pump can be started and the valve opened very slowly to drop the pressure until 0 mbar and thereafter the valve is opened fully to create complete vacuum. The argon valve can then be opened slowly to flush the system with argon gas (+−400 mbar). The valves is then closed and the vacuum valve is then opened to remove the gas from the system. This can be done twice to completely flush the system. Thereafter the system can be flushed with hydrogen gas (400 mbar) and pumped out with vacuum. Thereafter the hydrogen can be filled in the chamber until 600 mbar in this case. All the valves is then closed and the furnace is heated up to 600° C. Once the temperature is 600° C. and the system is safe, the sample is placed in the exact center of the furnace and left for the duration of 4 hours. Thereafter the sample (once cooled) can be analyzed by the XRD to find traces of Nickel hydroxide after the reduction step.

### Arc Furnace

The arc furnace is a very specialized high beam melting furnace used to liquefy and solidify metals under high temperatures to either change the structure of the metals or to see what effects it has on hard materials. The furnace using argon gas to purge the chamber, this is usually done about three times to make sure the chamber environment is clean. The inside of the chamber, the copper and metal sample chamber is also cleaned properly before use. The arc furnace uses a vacuum pump to pump out the gases and to maintain a desired pressure in the system. The arc furnace also has high power generator which generators the main power source for the beam. Once the chamber is clean and all safety checks are done, the getter sample is placed in the sample chamber. The getter consists of a pure titanium melted pellet previously prepared for the arc furnace test. The titanium getter is important for the system as it acts as an oxygen consumer (oxygen getter) to remove all the oxygen from the chamber before the sample can be melted. This is important as you want an oxygen free zone when melting the sample. The titanium is good for this purpose because it reacts very rapidly with oxygen and this can be tested by the colour of the titanium metal after is has been melted. The blue and yellow colour usually shows signs of oxygen and if all oxygen has been removed the titanium metal will remain silvery in colour. This test is done before testing the desire sample so as to make sure all the oxygen is removed from the chamber. Once this the sample can be melting using the same procedure as for melting the titanium getter. It is however very important that the sample be made into a pellet using the hydraulic press as the arc furnace does not take powdered samples. The pressed pellet sample is melted about five times on each side to get a complete and uniform representative sample. Only once this is done is the sample completely melted and can then be analyzed or treated further.

### In-Situ XRD Flowing Hydrogen Gas Reduction

For the in-situ set up, the material is prepared the same as it would be for an X-ray diffraction experiment with the difference being in the placement and sample holder of the set-up. The sample must be place on a small plastic stand and placed vertically in the small furnace surrounding the sample and tightened into place. The X-ray detector and X-ray beam is therefore on opposite sides of the furnace with a glass screen to view the sample through. The necessary gas tubes (in this case hydrogen) is connected on the incoming end to make contact with the sample in the holder and the gas pressure and flow is setup corrected before starting the step up program.

The experiment usually runs for a few hours depending on the temperature range and step changes made. The program will therefore capture all the XRD patterns and necessary data during the run to be analyzed at the end.

### Heat Treatment

For the heat treatment experiment the aim was to change phases of the Lanthanum Nickel compound formed during the reduction stages. The ratio according to the phase diagram, was slightly shifted to the left (the lanthanum ratio was slightly higher than nickel in the AB5) and therefore to change the phase required that the temperature was increased to 1000° C. and cooled slowly under a controlled environment (step cooling). This meant that the phase diagram needed to be consulted for the LaNi5 and the experiment designed according to it.

The sample was first prepared by cleaning the silicon tube used in the experiment and the sample was placed inside (+−1 g) of sample. The neck of the tube was burnt using a blow torch and then vacuum sealed using a specialized vacuum pump and piping system to completely remove all the air in the tube. This process takes around 30 min to completely obtain vacuum. The tube is then sealed using the blow torch again to obtain a smaller tube and this is then weighed and placed into the pit furnace. The furnace is then programmed accordingly. The program used for the heat treatment program was a 12 hour ramp up time to 1000° C., maintaining the temperature at 1000° C. for 5 days, followed by a 24 hours ramp down time to ambient temperature.

### Summary of the Reduction Experiments:

The methods used was mainly X-Ray Diffraction to initially analyze the contents of the material and to analyze the material during and after main process conditions were changed. The XRD machine used was the Bruker D8 Advance diffractometers for Powder Diffraction (XRPD) and also the D8 twin twin for Powder Diffraction. The pyro-metallurgical process equipment included MPF Furnace, Arc Furnace and Pit Furnace. Other laboratory equipment included glovebox, fume-hood, pellet press etc. The following is the summary of the experimental methods for the reduction process:

TABLE 2
The reduction experiments done for all the material

| Sample/Method | Temperature | | |
|---|---|---|---|
| name | (° C.) | Pressure(mbar) | Other conditions |
| Initial Reduction | 600 | 600 | 4 hrs |
| 1 (no special | | | |
| requirements) | | | |
| Reduction 2 | 250 | 800 | overnight |
| (particle size) | | | |
| Reduction in-situ | 30-300-30 | 1 bar | Flowing H2 gas—step |
| | | | change 30-300-30 |
| Reduction 3 | 250-500 | 800 | Vacuum at 500 |
| Reduction without | 250 | 700 | No vacuum for 4 hrs |
| vacuum | | | special handling |

### Results and Discussion

The results for the first part of the project is presented by the XRD patterns of the initial material, the mixed material and the negative material from the electrodes. This is to establish what chemical elements are present and to give an idea of what the compositions might be.

### Initial Measurements

The initial measurements were to analyze the material and establish a process path which can be followed initially to understand more about the material.

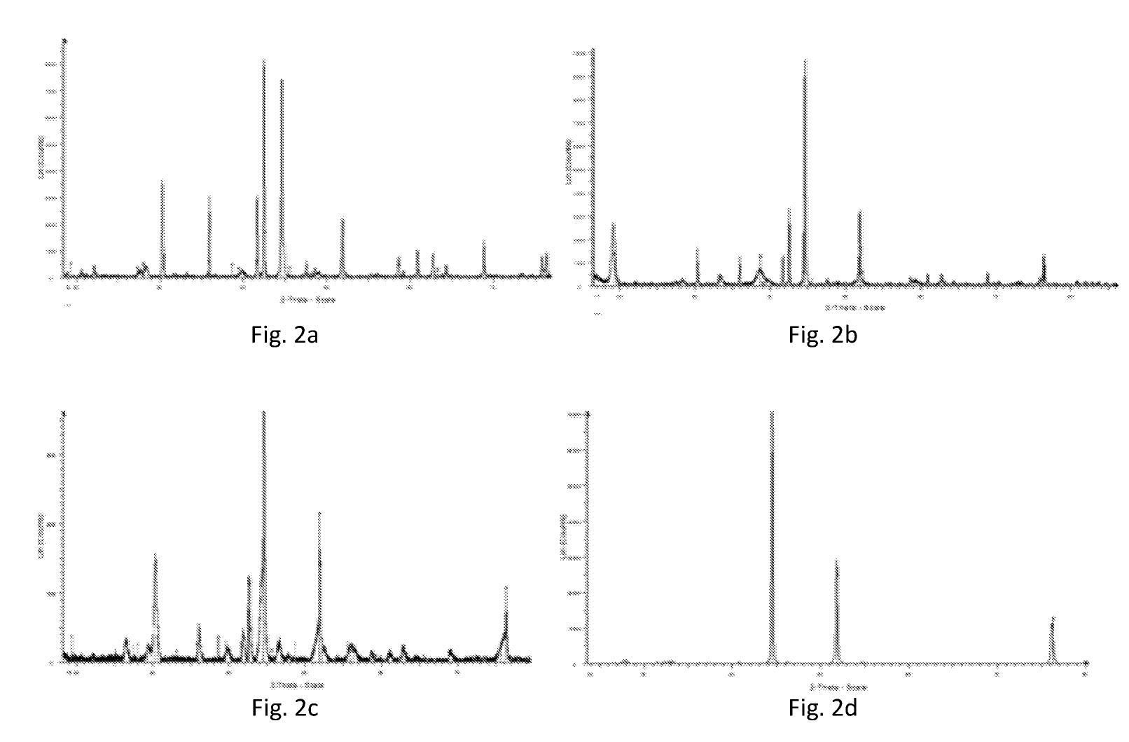

FIGS. 2a-2d show X-ray diffractograms (XRD) for (a) Initial negative electrode material (b) Initial mixed material (c) reduced negative material (d) reduced mixed material.

It's clear from these results that after reduction of the initial mixed material for the reduced mixed (FIG. 2d) there is only nickel present whereas for the reduced negative (FIG. 2c) there is nickel, AB₅ and traces of Ni(OH)₂. This proves that the reduction conditions initially were not ideal for the material and hence the conditions were adjusted.

### Reduction for Crushed and Non-Crushed Material (Reduction 2)

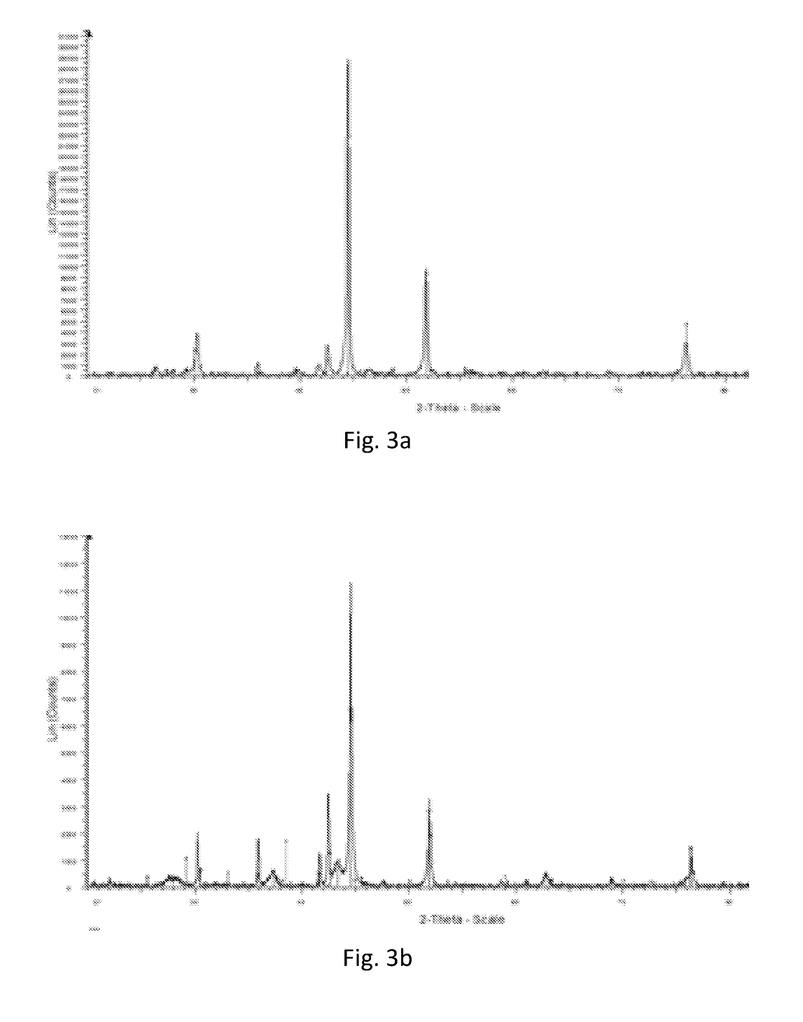

FIG. 3(a) shows an XRD pattern for mixed crushed sample after reduction, and FIG. 3 (b) shows a mixed non-crushed sample after reduction.

The comparison of the two samples show that non-crushed sample after reduction with Hydrogen and same conditions does not have much difference although non-crushed sample is favoured because the traces of LaNi₅ is slightly more.

### Initial Arc Melting Process

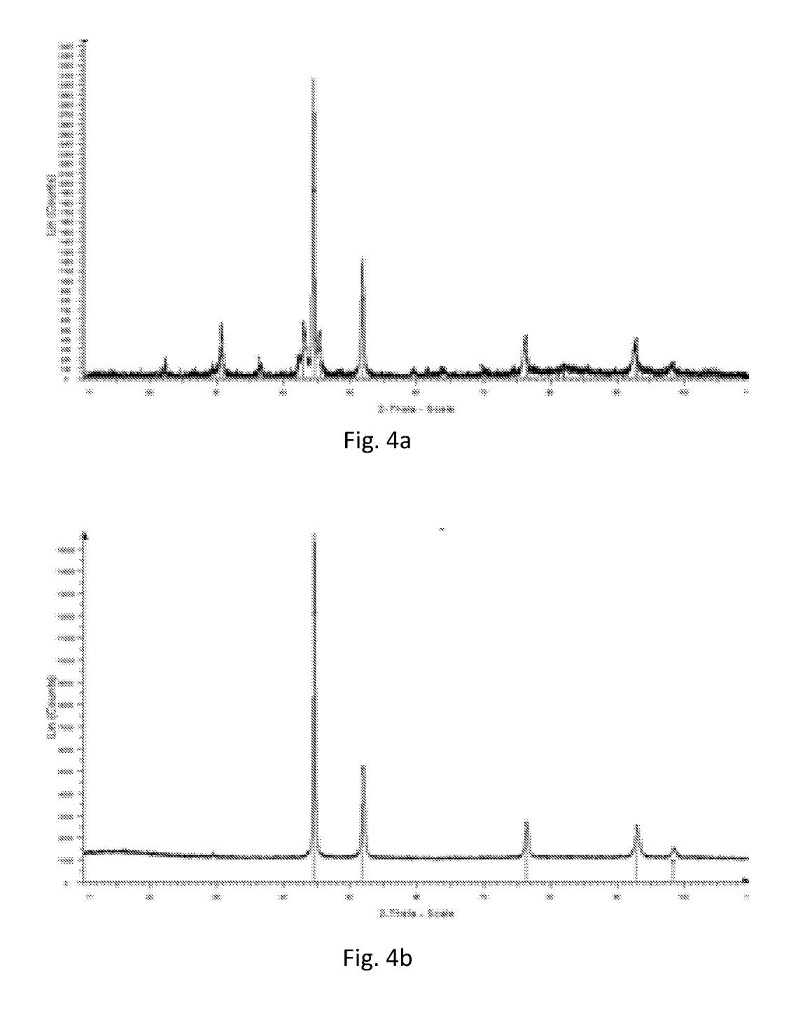

FIG. 4(a) shows an XRD for negative material after reduction 1 and arc melting, whereas FIG. 4(b) shows an XRD for mixed material after reduction 1 and arc melting.

The mixed material shows traces of nickel only and therefore means that the process needs to be improved. This however also indicates that the Lanthanum from the AB₅ has been consumed and therefore the reduction process is not effect. Also the negative material contains more LaNi₅ which is expected initially but also maintains it throughout the process. This could also therefore mean that depending on the initial ratio of the mixed material (negative and positive) will have an effect on the amount of LaNi₅ present at the end of the process.

Reduction In-Situ with Hydrogen Gas Flow

Conditions: 1 bar Hydrogen gas pressure, Step change for temperature 30° C.−300° C.−30° C. in increments of 50° C. Each scan contained short and long scans (Short scan 30 min, Long scan 3 hr).

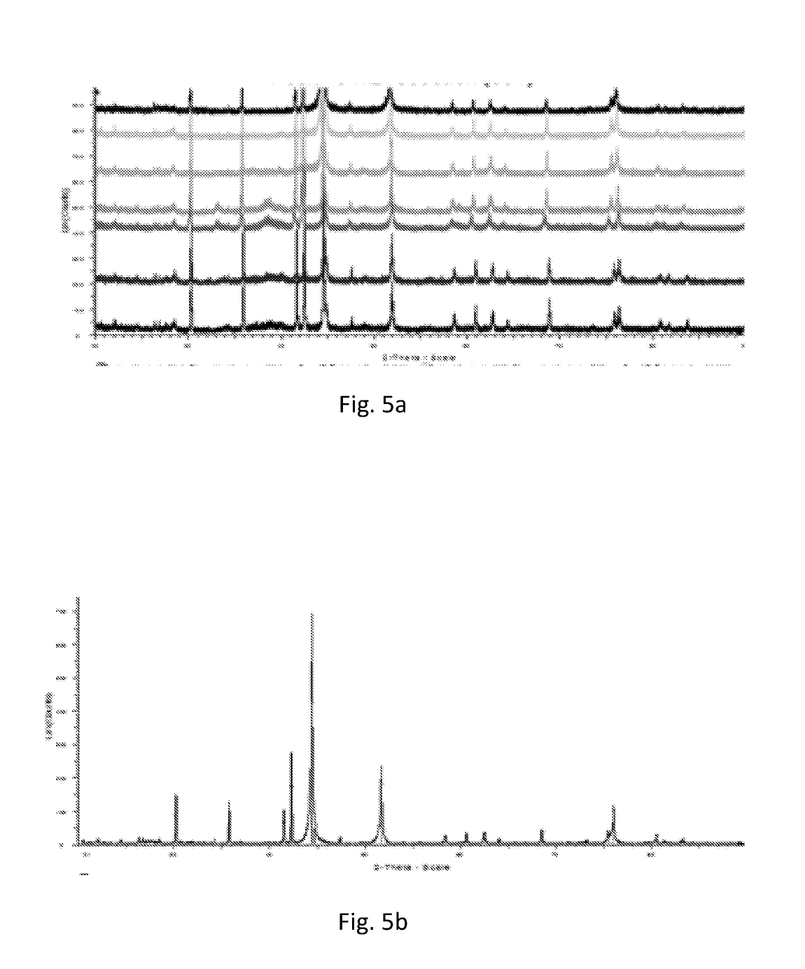

FIG. 5(a) shows a series of XRD patterns from reduction in-situ for mixed material. FIG. 5(b) shows the end scan XRD pattern for reduction in-situ for mixed material.

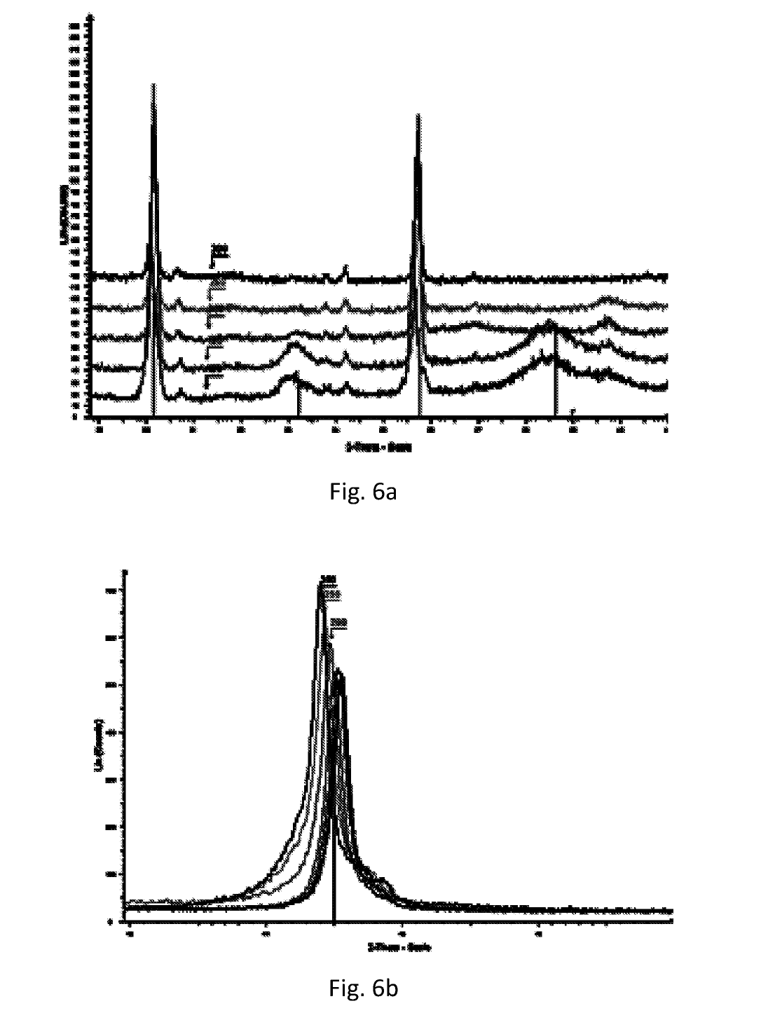

FIG. 6(a) shows the XRD pattern for the reduction of Ni(OH)₂ at different temperatures showing the reduction from the orange and pink patterns (bottom) to the blue pattern (top, at 200° C.). FIG. 6(b) shows the XRD pattern for Nickel showing an increase in the intensity from 200° C. and taken from the same XRD pattern scan as FIG. 6(a).

This therefore proves that the in-situ reduction experiment under flowing hydrogen can reduce the Ni(OH)₂ and at the same time increases the intensity of the Nickel. Also the LaNi₅ intensity is slightly higher when compared to the reduction with the MPF. This therefore stands to reason that the in-situ reduction experiment is better suited for this type of system and is due to the reaction kinetics:

Ni(OH)₂₍ₛ₎+H_{2(g)}→Ni₍ₛ₎+2H₂O_{(g)} (7)

Therefore based on the forward reaction being favoured it means that the water vapor will be formed and be removed from the system at the same time. Therefore looking at the reaction rate constant for the above reaction

[Ni][H₂O]/[Ni(OH)₂][H₂]=K

And with the solids in the equation being equal to 1 it means the reaction will therefore depend on the partial pressure of the gases (water vapor and hydrogen gas)

[1][pH₂O]/[1][pH₂] and the water vapor pressure will tend to 1 too because it is being removed from the system, so therefore the equation will always be >>0.

Based on the success of the reduction stage in-situ, it stands to reason that adding the additional Lanthanum according to the correct ratio of LaNi₅ (AB₅) and allowing the nickel to react with this lanthanum we can produce the desired LaNi₅ again and therefore achieve the recycled rate of the spent mixed material. However achieving this also means refining the reduction stage to a more suitable process and therefore hence the different techniques for improvements was investigated.

### Reduction at 250° C. and 700 Mbar Pressure Under Argon Environment

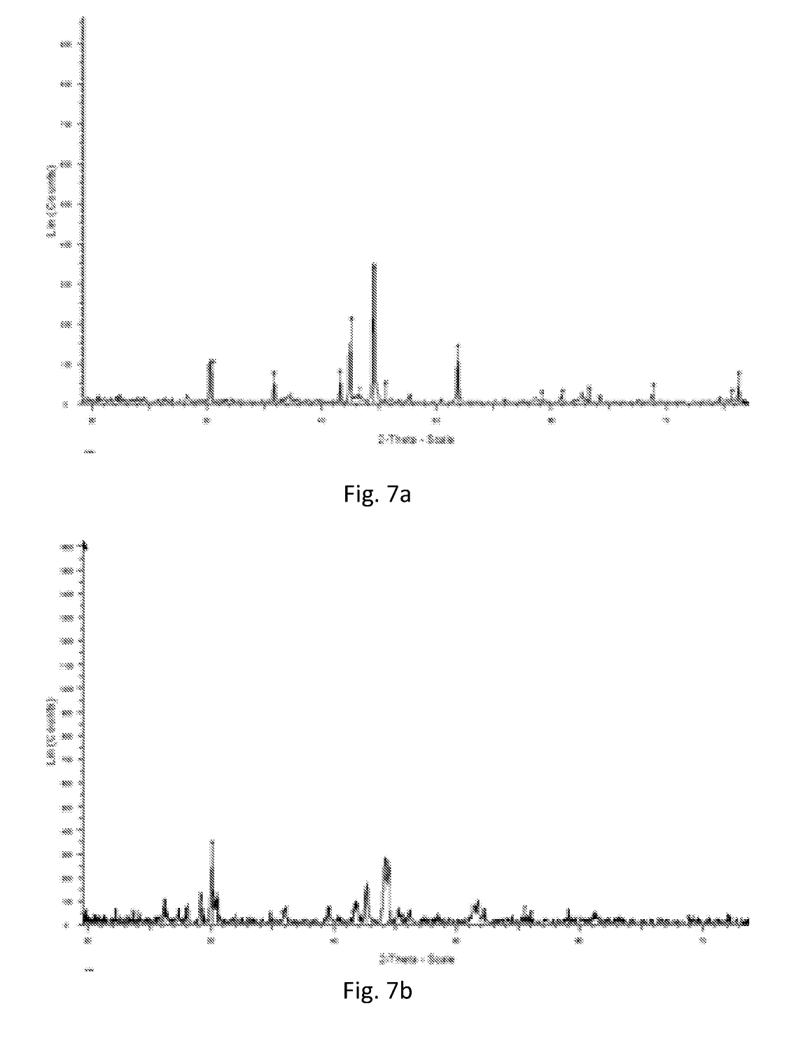

FIG. 7(a) shows the XRD pattern for the pure mixed material before reduction. FIG. 7(b) shows the XRD pattern for pure mixed material after reduction. Both samples were initially stored under argon environment to avoid formation of La₂O₃.

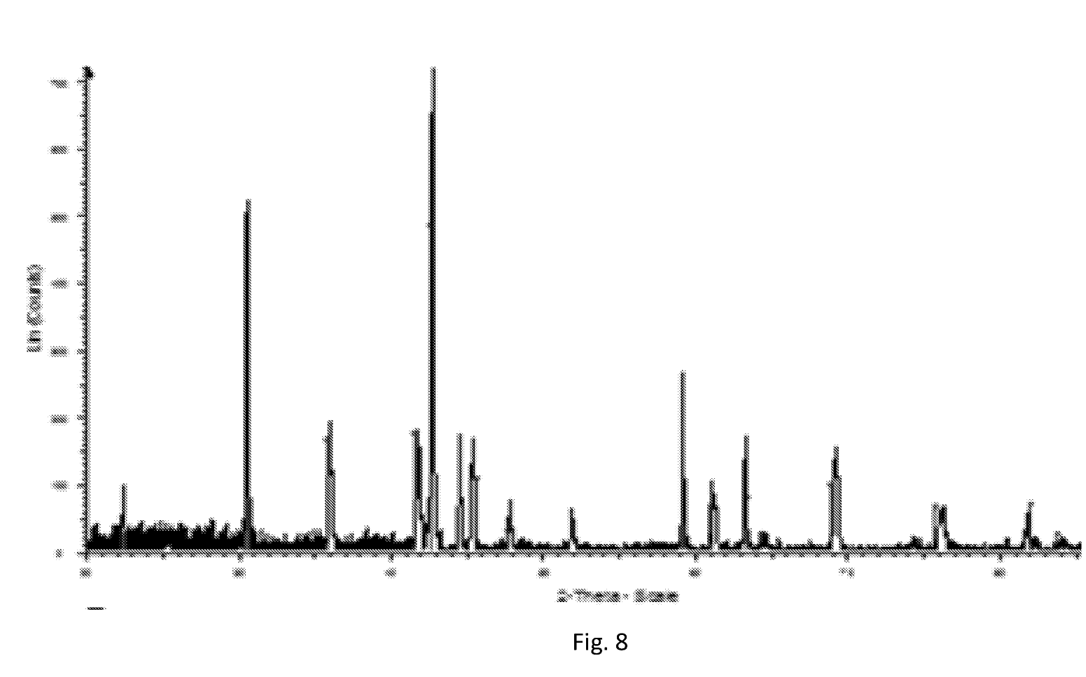

These results shows that the Nickel intensities are decreased and could therefore mean that the Lanthanum added to the system has to some extent reacted with the Nickel because of the small traces of LaNi₅, although it is not at a desired state yet. It was then decided that a reference sample of pure LaNi₅ can be produced and used as a comparison for the desired material. FIG. 8 shows the XRD pattern for this reference LaNi5 produced using the arc melting process. Also the patterns show less La₂O₃ which therefore means that it is important for the material to be stored in an oxygen free environment.

### Heat Treatment

Based on one of the reduction experiments where the conditions were changed to 300° C. at 800 mbar H₂ with the MPF, the results showed a La₂Ni₃ phase which was unusual for these conditions and the heat treatment experiment was introduced to change the phase of the material to the LaNi₅ based on the LaNi₅ phase diagram.

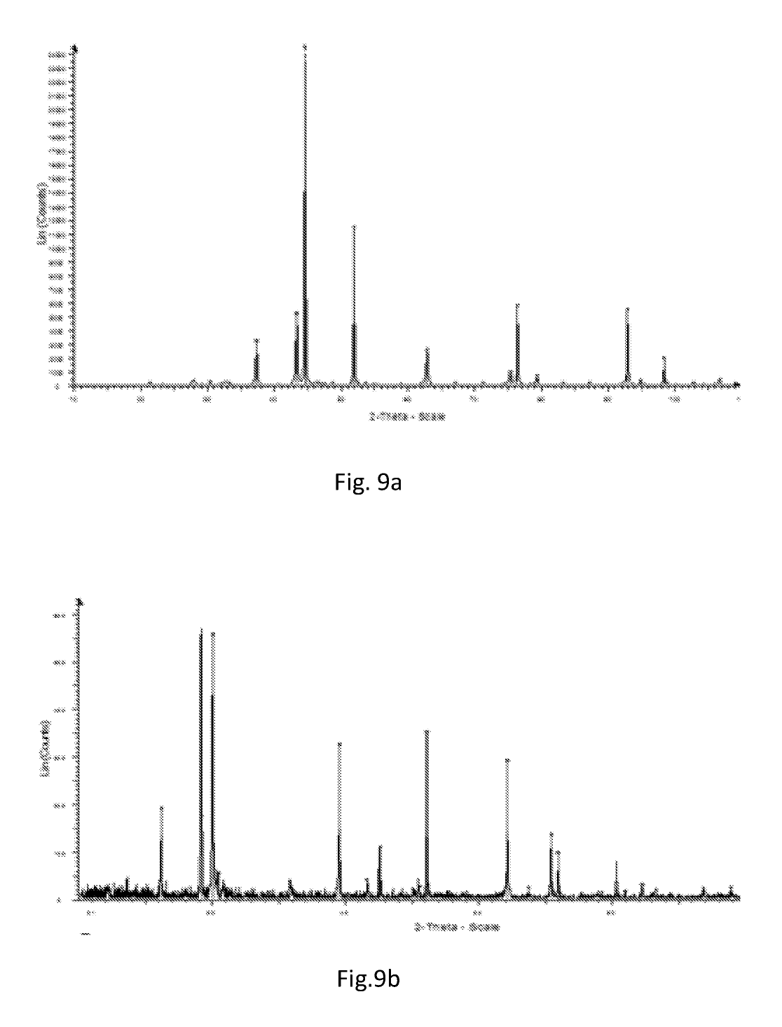

FIG. 9(a) shows the XRD pattern for the material after reduction showing the La₂Ni₃ phase in red and Ni also present. FIG. 9(b) shows the XRD pattern for the material in FIG. 9(a) after heat treatment.

These results shows that the phases have changed from La₂Ni₃ to LaNi₅ based on the programmed pit furnace experiment but however shows high intensities of La₂O₃ (red patterns in FIG. 9b) which is not desired. From the figure it is clear that the LaNi₅ phase can be achieved using this method, although it is still also clear that there is La₂O₃ still present in the process (strong peaks of oxides) and this needs to be further investigated. The scan also shows no or very few amounts of nickel metal which suggests that the nickel has reacted with the lanthanum and the AB₅ has been formed successfully.

### Scanning Electron Microscope (SEM) Images

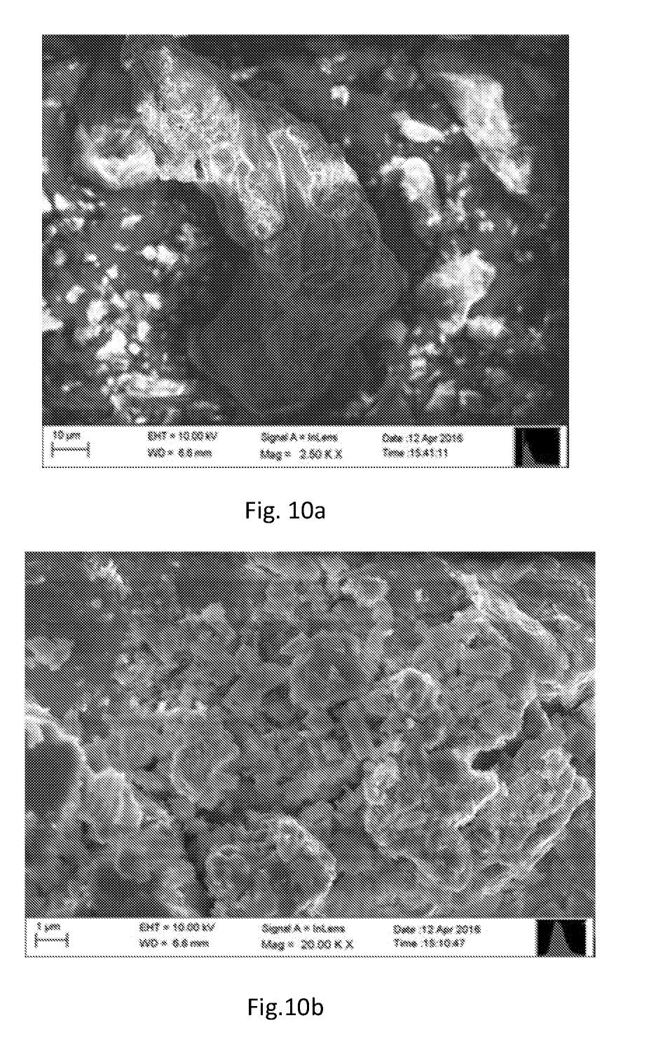

The SEM images were taken from the samples used in the reduction number 3 and heat treatment experiments to see what the La₂O₃ structure and traces of the LaNi₅ formed during these processes might look like. FIG. 10a shows the SEM image of the Heat Treatment sample showing traces of LaNi5 in the centered structure. FIG. 10b shows the SEM image of the Heat Treatment sample showing the main La2O3 structure. From FIG. 10a it is seen as a lump of nickel with traces of LaNi₅ inside the structure and in FIG. 10b it is only the La₂O₃ structure that is observed.

### Refined Arc Melting Process

Based on all the previous results it is clear that the LaNi₅ can be formed but with a more refined arc melting stage and using the refined reduction method also under argon stored environment. The results of the refined arc melting stage will then be compared to the reference LaNi₅ which was produced also by a more refined method.

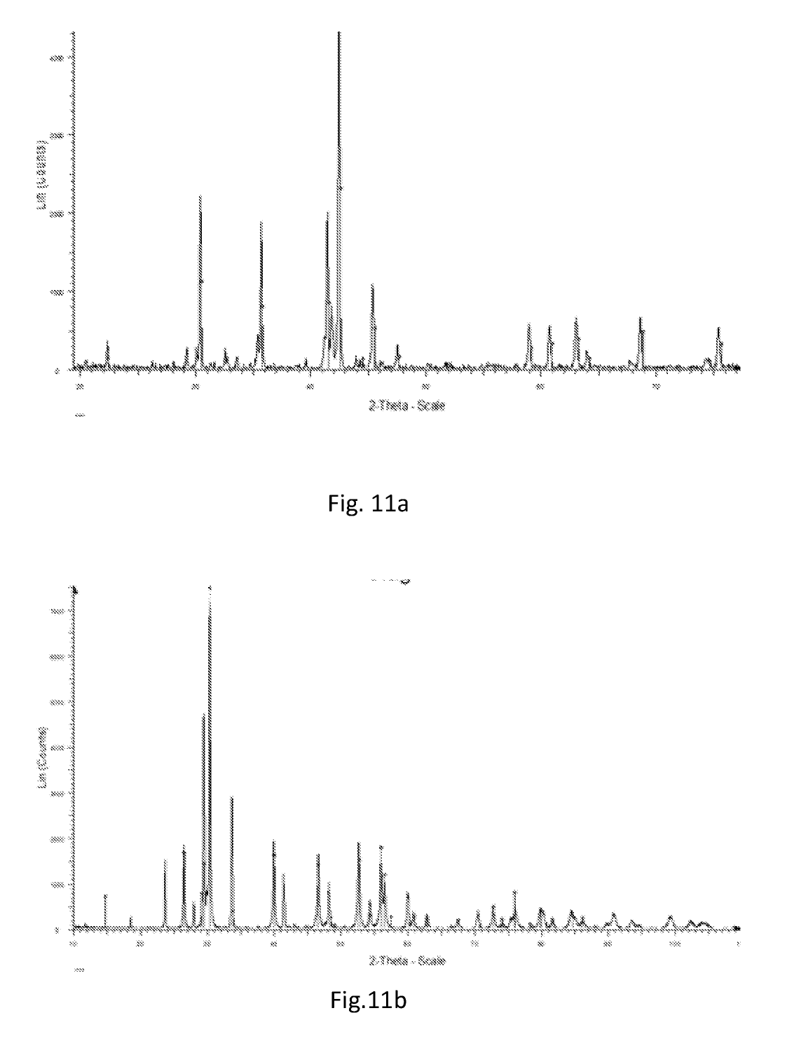

FIG. 11a shows the XRD pattern for the refined arc melting stage showing only LaNi₅ and slight traces of Nickel. FIG. 11b shows the XRD pattern for the slag material produced from the arc melting stage mainly showing La2O3 with traces of LaNi5.

Based on the figure shown, it is clear that the refined arc melting method has proven to show an increase in the LaNi₅ phase. This therefore means that the refining of the process can therefore produce a higher quality material. However the slag produced from the material was also analyzed and based on the calculation results showed a 25.24% loss due to slag.

The slag is formed after the first melt on most occasions during the arc melting process and usually moves to the outer layer. This could therefore mean that it could be easier to separate at a later stage of the process.

### Steps and Observations

Try and use average amount of sample (around 2-3 g)
After each melt remove slag and re-melt
Keep the amount of melts to a minimum
Try and keep the exposure to air of the sample as short as possible
Study the sample and look closely at where slag is formed and where metallic is formed
Add initial 10% extra La to addition La
Place La and pellet in close contact with each other
Weight all sample and slag after each melt
Add the extra-extra La after the second melt when most of the slag is removed
Analyze all the material

### Conclusion and Outlook

To conclude it was initially not easy to establish a process path where it was obvious or not that the mixed material can produce a LaNi5 compound and hence the trial and error experiments especially regarding the reduction phase. However with the process conditions changes made, it become more obvious which conditions would be better suited for the material until a reduction process of 250° C. with no vacuum pumping and pressure of 700 mbar under Hydrogen atmosphere for 4 hrs. This process can also be further investigated but for these purposes it seems to be successful. Also the arc melting process took some work and different techniques to prepare sample specifically with no or limited exposure to air. Hence the steps and observations which was noted based on this material and process equipment used. The overall result is that the material can be recycled to produce a good quality LaNi5 compound and this can be incorporated into the process operations as an optimized version of the proposed process flow for the Nickel Metal Hydride material.

### REFERENCE

[1] Academic Database 2000-2014, Nickel-metal hydride battery, website: www.en.academic.ru/dic.nsf/enwiki/11817092 (visited 5 Feb. 2016)
[2] Ovshinsky et al. Chemically and compositionally modified solid solution disordered multiphase Nickel hydroxide positive electrode for alkaline rechargeable electrochemical cells, Ovonic Battery Company Inc., Troy, Mich., (1994) United States Patent
[3] Robert C. Stempal et al, Ovonic Battery Co. Nickel-metal hydride: Ready to serve, November (1998), 29-34
[4] Nilar Doc No: 73-F006-R01. Nilar, Product information, Nilar 12V Energy Module, website: www.nilar.com (visited 28 Jan. 2016)
[5] Nilar Doc No: 73-F001-R02. Nilar Technical Manual, Nilar Energy Battery, website: www.nilar.com (visited 28 Jan. 2016)
[6] Energizer, Nickel Metal Hydride (NiMH) Handbook and Application manual, version: NiMH02.01, Energizer Battery Manufacturing Inc. (2010), 800-383-7323 (USA-CAN), website: www.energizer.com (visited 29 Jan. 2016)
[7] Kwo-hsiung Young, Jean Nei, The Current Status of Hydrogen Storage Alloy Development for Electrochemical Applications, Materials, (2013), 6, 4574-4608; doi: 10.3390/ma6104574
[8] John J. C. Kopera, Inside the Nickel Metal Hydride Battery, Cobasys, (2004), website: www.cobasys.com/pdf/tutorial/inside_nimh_battery_technology.pdf (visited 4 Feb. 2016)
[9] Sun Olapiriyakul, Reggie J. Caudill, Thermodynamic Analysis to Assess the Environmental Impact of End-of-life Recovery Processing for Nanotechnology Products, Environmental Science Technology, (2009), 43, 8140-8146
[10] Jirang Cui, Lifeng Zhang, Metallurgical recovery of metals from the electronic waste: A review, Journal of Hazardous Material 158 (2008) 228-256
[11] Hazuki Otsuka, Masanobu Chiku, Eiji Higuchi, and Hiroshi Inoue, Characterization of Pretreated Co(OH)2-Coated Ni(OH)2 Positive Electrode for Ni-MH Batteries, ECS Transactions, 41 (21) 7-12 (2012) 10.1149/1.3695096, The Electrochemical Society
[12] Q. S. Song, C. H. Chiu, S. L. I. Chan, Ball-milling processing of nanocrystalline nickel hydroxide and its effects in pasted nickel electrodes for rechargeable nickel batteries, Journal of Solid State Electrochemistry (2008), 12:133-141, DOI 10.1007/s10008-007-0370-9
[13] Tobias Muller, Bernd Friedrich, Development of a recycling process for the nickel-metal hydride batteries, Journal of Power sources 158 (2006), 1498-1509
[14] A. M. Bernandes, D. C. R Espinosa, J. A. S. Tenorio, Recycling of batteries: a review of current processes and technologies, Journal of Power sources 130 (2004), 291-298
[15] F. Feng, D. O. Northwood, Effect of surface modification on the performance of negative electrodes in Ni/MH batteries, International Journal of Hydrogen Energy 29 (2004) 955-960
[16] Chao Deng, Pengfei Shi, Sen Zhang, Effect of surface modification on the electrochemical performances of LaNi₅ hydrogen storage alloy in Ni/MH batteries, Materials Chemistry and Physics 98 (2006) 514-518
[17] Carla Lupi, Daniela Pilone, Ni-MH spent batteries: A raw material to produce Ni—Co alloys, Waste Management 22 (2002) 871-874
[18] Junmin Nan, Dongmei Han, Minjie Yang, Ming Cui, Xianlu Hou, Recovery of metal values from a mixture of spent lithium-ion batteries and nickel-metal hydrides batteries, Hydrometallurgy 84 (2006) 75-80
[19] L. Pietrelli, B. Bellomo, D. Fontana, M. R Montereali, Rare earths recovery from NiMH spent batteries, Hydrometallurgy 66 (2002) 135-139
[20] H. Heegn, B. Friedrich, T. Muller, R Weghe, Closed-loop Recycling of Nickel, Cobalt, and Rare earth metals from spent Nickel-Metal Hydride-Batteries, XXII IMPC-Cape Town (2003) Paper 36, OP39B
[21] Erik Svensson Grape, Prof. Dag Noreus, Regeneration of anodic material from prepared and used Nickel-metal hydride batteries, Stockholm University (2015)
[22] Richard Lemmons Blog, Global Climate Notes, Rechargeable Batteries Optimized Recycling processes for Advanced Batteries Nickel Metal Hydride NiMH, updated 2014, http://www.globalclimatenotes.us/rechargeable-batteries/optimized-recycling-processes-for-advanced-batteries-nickelmetal-hydride-nimh.html (visited 3 Feb. 2016)
[23] Caiyun Wang, Cathodic materials for nickel-metal hydride batteries, PhD Thesis, Institute for Superconducting and Electronic Materials, University of Wollongong (2003) http://ro.uow.edu.au/theses/192 (visited 31 Jan. 2016)
[24] G. G. Libowitz, Metallic Hydrides; Fundamental Properties and Applications, Journal of Physical Chemistry Solids Vol 55, No 12 (1994) 1461-1470
[25] Barbara L. Dutrow, Christine M. Clark, Geochemical Instrumentation and Analysis X Ray Powder Diffraction (XRD), updated 2015, http://www.serc.carleton.edu/research_education/geochemsheets/techniques/XRD.html (visited 11 Feb. 2016)
[26] Dhanesh Chandra, Wen-Ming Chien, Anjali Talekar, Metal Hydrides for NiMH Battery Applications, Material Matters, Volume 6, Article 2, (2016), www.sigmaaldrich.com/technical-documents/articles/material-matters/metal-hydrides-nimh-batteries.html (visited 12 Feb. 2016)
[27] G. S. Yuasa Corporation, Improvement of Capacity of Nickel-Metal Hydride Battery: Clarification of the optimal composition of the electrode Spring 8 (2009), T. O. Zaki et al, Journal of Alloys and Compounds, 446-447, 620-624 (2007), www.spring8.or.jp/pdf/en/indu_appli/p26-27.pdf (visited 3 Feb. 2016)
[28] Thomas Holm, Synthesis and characterization of the nanostructured magnesium-lanthanum-nickel alloys for Ni-metal hydride battery applications, NTNU-Trondheim Norwegian University of Science and Technology, 2012, pg 10 http://www.diva-portal.org/smash/get/diva2:565958/FULLTEXT01.pdf (visited 9 May 2016)
[29] Wikipedia, Fuel cell cars, Configuration of components in a fuel cell car https://en.wikipdia.org/wiki:Fuel_cell (visited 25 May 2016)

### Appendix A: Calculations for Lanthanum Addition to the System

Using the A/B ratio as 7.8 (from the initial material sent from Nilar)

TABLE 3
The atomic weight percentages for
the initial mixed material and for the
desired phase of AB5

| (LaNi_{7.8}) | | (LaNi₅) | |
|---|---|---|---|
| ratio 7.8 | | ratio 5 | |
| Ni | 76.683 | Ni | 67.875 |
| La | 23.316 | La | 32.128 |
| total | 100 | total | 100 |

Therefore the aim would be to move from the 7.8 ration phase of nickel and lanthanum to the 5 ratio phase by adding additional lanthanum during the process.

The calculations for the sample weight and lanthanum addition are as follows:

First to establish the correct amount of sample weight for the arc melting: 2 g

Lanthanum based on 2 g sample: 2×23.31676/100=0.46633 g

Nickel: 2×76.68324/100=1.53366 g

Therefore calculate the total sample amount:

1.5366×100/67.87=2.259702 g total

Therefore new La: 2.259702×32.128/100=0.725997 g

Exact amount=0.725997−0.46633=0.259667 g add 10% gives 0.28562 g (round off to 0.32)

Calculate the Percentage of Slag Obtained from the System

Exact sample weight for arc melting=2.0678 (pellet) and 0.3148 g (La)=2.3826 g

TABLE 4
The amount of melts during the arc melting process and the
related weights of sample and slag

| Melt | Total sample weight | Total slag weight |
|---|---|---|
| number | after melt (g) | after melt (g) |
| 1st | 2.2856 | 0.2826 |
| 2^{nd} | 1.9265 | 0.4712 |
| 3rd | 2.1235 | 2.1235 − 2.0966 = 0.0269 |

At this stage the extra La was added to account for the losses due to the formation of La₂O₃

Total new sample after the 2 melts: 1.4392 g (assume all Nickel)

Total sample=1.4392×100/67.87=2.1205 g

La=2.1205×32.128/100=0.68127 g

Therefore the 3^{rd} melt sample=1.4392 g (sample of all Ni)+0.6843 (extra La)=2.1235 g

After_{3R} melt weight=2.0966 g (loss=2.1235-2.0966=0.0269 g)

Therefore percentage losses=total slag/total sample×100:

Total amount of sample: 2.3826 (initial sample)+0.6843 (extra La added)=3.0669 g

Total slag=0.2826+0.4712+0.0269=0.7807 g

% loss=0.7807/3.0669×100=25.45% (However this can still be recycled and refined further!)

### Calculation for % Lanthanum Added

Initial La for pellet (0.3148 g)+extra La (0.6843 g)=0.9991 g

Total sample=3.0669 g

% La=0.9991 g/3.0669×100=32.57%

### Appendix B: Extended Results from Other Contributing Experiments Performed

### Negative In-Situ Reduction:

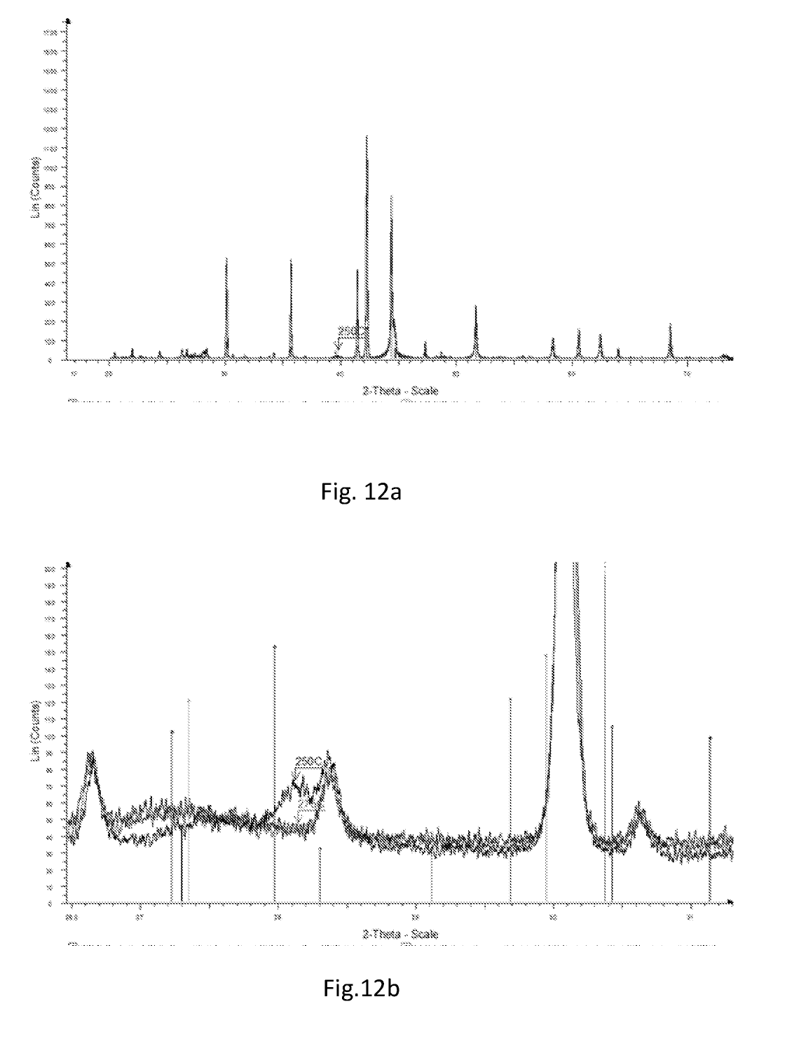

Based on the In-situ reduction results the negative material was also reduced under the same conditions as the positive but because it already contains LaNi₅ it is considered to be easier to reduce and therefore the challenge for the negative material is reducing the La(OH)₃ which is slightly more challenging than the Ni(OH)₂. FIG. 12a shows the XRD pattern end scan for Negative material in-situ reduction showing at 250° C. where the La(OH)3 peak is. The pattern still shows the nickel and LaNi5. FIG. 12b shows the XRD pattern for negative material showing a zoomed version of FIG. 12a where the decrease in intensity of La(OH)3 is between 250 and 275° C. These results show that to some extent in the negative material the La(OH)₃ is reduced but less when compared to Ni(OH)₂.

### Mixed Material Reduction at 300° C. and 800 Mbar Pressure Hydrogen Pressure

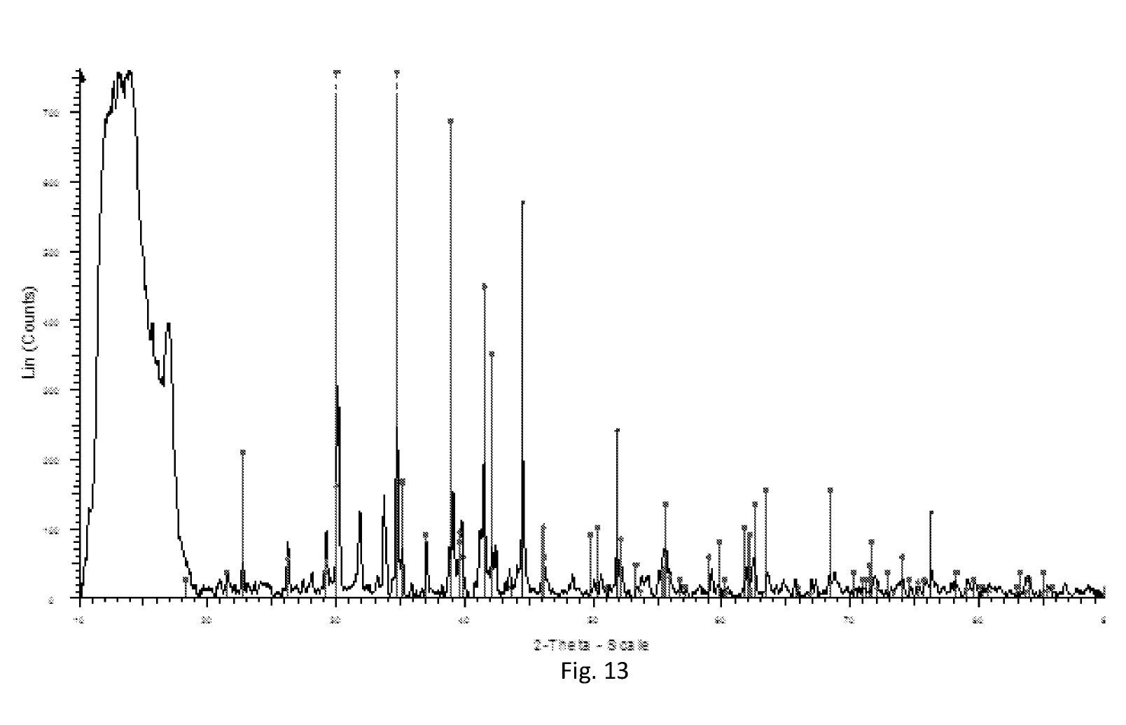

A few different methods were tried to achieve similar results with the in-situ experiment but was not entirely successful. The following was the reduction tried at 300° C. and 800 mbar pressure Hydrogen atmosphere with a vacuum heating step at 600° C. included after treating the material overnight and adding the additional Lanthanum and arc melted at the end. FIG. 13 shows the XRD pattern resulting from the reduction at 300° C. with vacuum heating at 600° C. method and after arc melting.

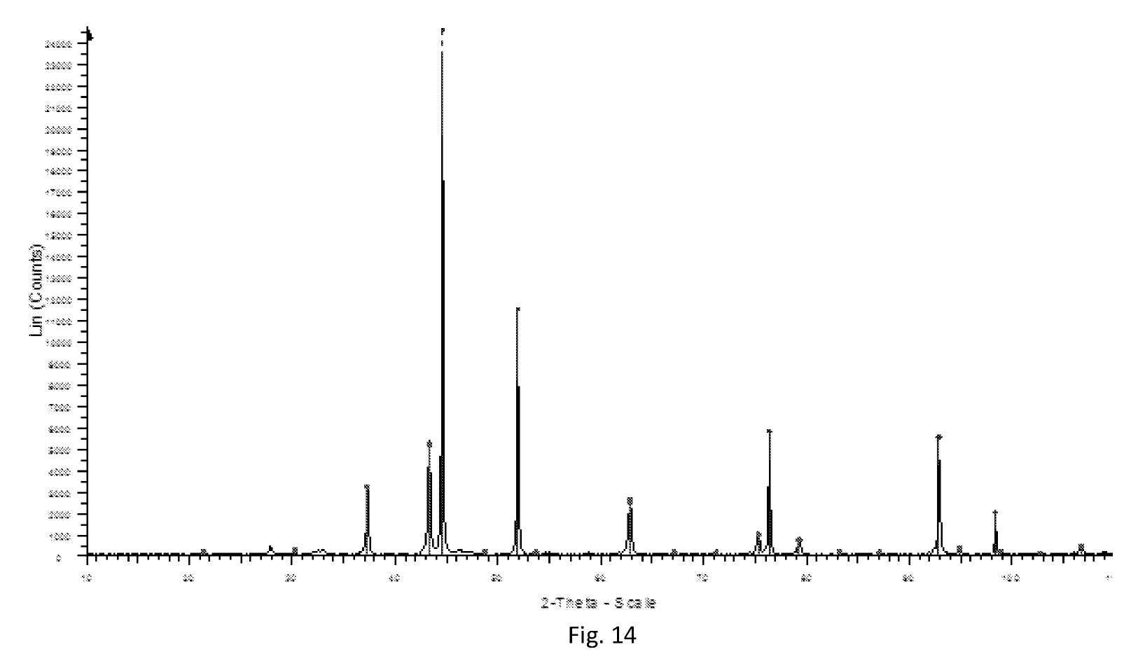

Based on this, it showed that the phase of La₂Ni₃ was present (the pink peaks) and therefore looking at the phase diagram for LaNi₅ it was decided that the material can be heat treated to reach the LaNi₅ phase (See the heat treatment results section). The material after reduction for the same process however showed a strange phase of material which hasn't been seen before with this type of material. The phase was a lanthanum nickel oxide (possibly LaNiO₃) as seen from FIG. 14. FIG. 14 shows the XRD pattern for the mixed material after reduction at 300° C. and vacuum at 600° C. The nickel (blue) is present together with the Lanthanum Nickel Oxide phase (red).

### The Reduction Stages Changed to 250° C. and Difference Between Vacuum and No Vacuum

Based on the in-situ reduction experiment, it was seen that the optimal temperature for reduction was around 250° C. and therefore it would make more sense to reduce the material at this temperature and not increase beyond this as to save energy and to continue using the MFP vacuum furnace as it is seen to be a cheaper option (in industry) than the flowing Hydrogen. The in-situ experiment however showed that it is possible to reduce the Ni(OH)₂ material as desired and obtain nickel metal which can be used for further treatment. The experiments that followed however showed that it is also possible to achieve the desired reduction conditions using the vacuum MFP furnace but meant that the parameters of the reaction needed to be adjusted accordingly as the material is sensitive.

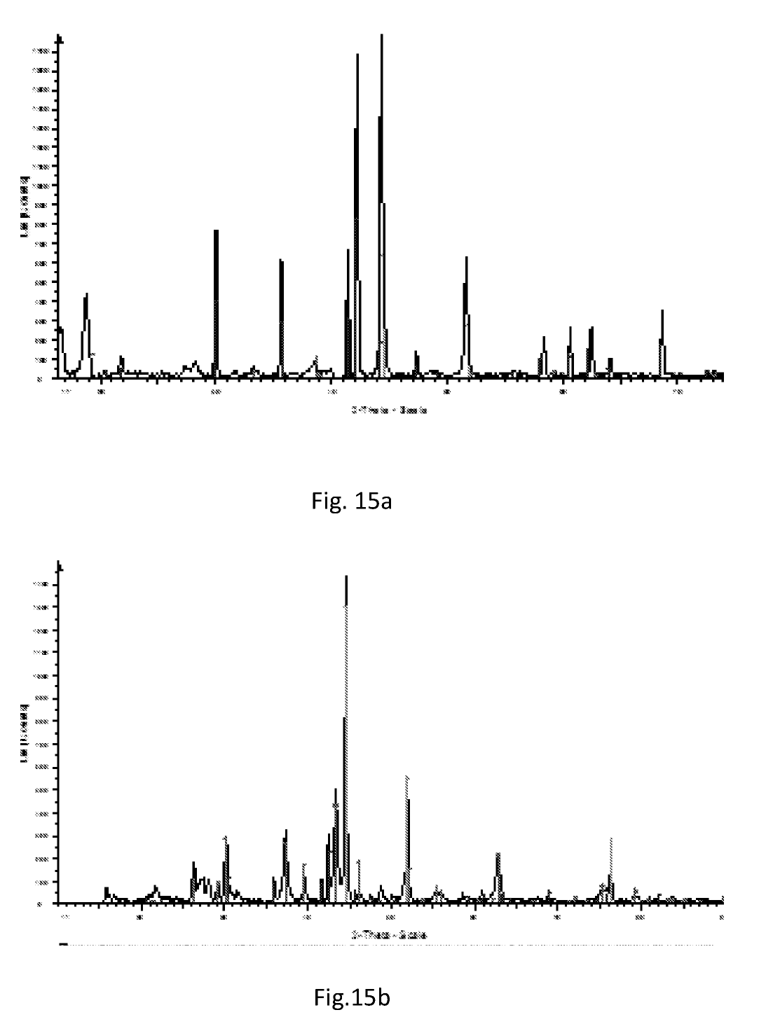

FIG. 15a shows the XRD pattern for the new reduction of the mixed material before reduction, whereas FIG. 15b shows the XRD pattern for the new reduction of the mixed material after reduction.

Once the desired reduction stage was achieved with the MFP furnace, the limiting factor to achieve desired recycling rates of the AB₅ was at the arc melting stage where the material seems to not react completely (that is the lanthanum and nickel). For this a reference sample was done with pure nickel and lanthanum in the arc furnace to see if the desired ratios can be achieved and therefore the aim would therefore be to achieve the same or similar XRD pattern as the reference sample. It was also observed that there was a fair amount of La₂O₃ material which is undesired and still needed to be treated and therefore the conclusion was drawn that the lanthanum in the system reacts (to a certain degree) with the oxygen in air. This was proved with material that was standing and exposed to air over some period of time and analyzed again using XRD. The test was to determine whether the lanthanum was reacting with oxygen and therefore looking at figures in the initial section, it shows true to this point. It was then decided to store all materials in a glove-box argon environment after each stage to reduce this chance of the lanthanum reacting and therefore causing loses.

### The Reduction Stages and Arc Melting Done Under Storage of Argon Environment

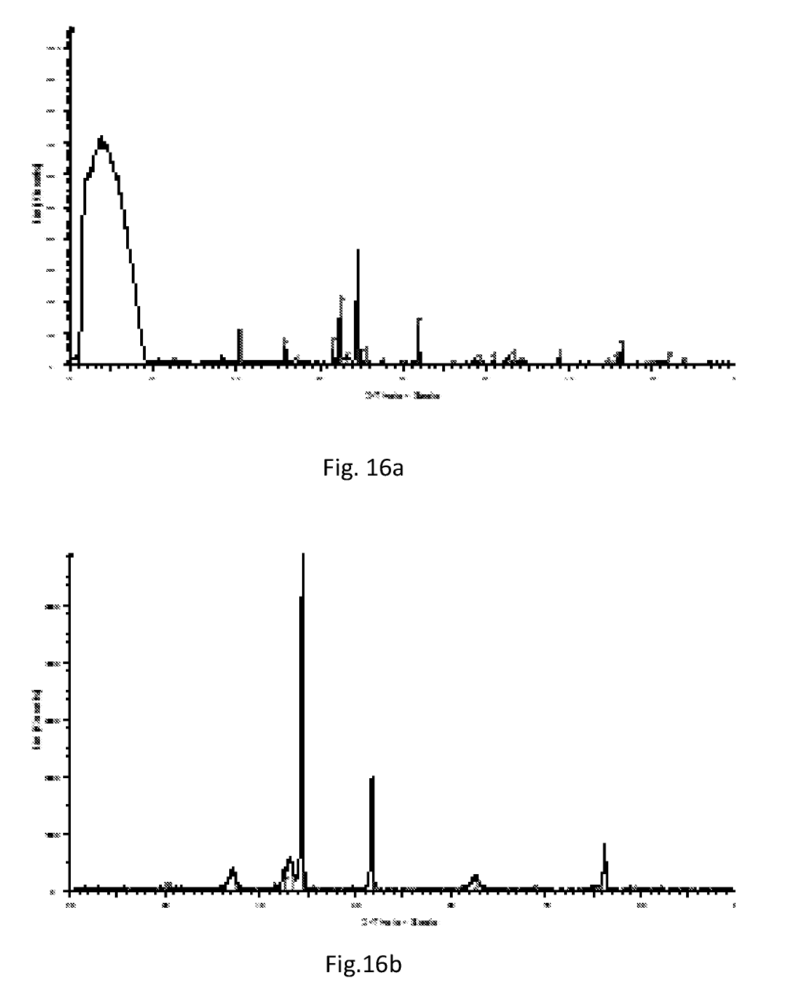

Based on success of the methods used and formation of AB₅ it was decided that the process can be refined further to achieve an even higher degree of recycled material but refining the reduction stage and arc melting stages. It is therefore seen that the AB₅ can be obtained so therefore the aim would be to refine the process. The shortcoming of the method is that exposure to oxygen causes the material to form lanthanum oxide and therefore reduces the LaNi₅ as the lanthanum oxygen reaction is favoured. The approach is therefore to use the cheapest and easiest methods and if possible reduce the process stages but still produce the desired material. The following XRD patterns are based on a more pure form of the material (by not exposing it to oxygen) and still doing the reduction and arc melting stages but with a more refined approach.
FIG. 16a shows the XRD of the initial mixed material. FIG. 16b shows the mixed material after reduction.
The difference between the initial sample before reduction and after reduction is the intensity of the nickel peaks have increased and the LaNi₅ is less. Also traces of Nickel oxide is present after reduction which is strange in this case and could also benefit from further investigations.

Looking at the metallic sample after the arc melting, it was observed that the material is mainly nickel and that the lanthanum did not react as expected. The outer layer which is considered to be the slag contains mainly La₂O₃ and nickel and traces of LaNi₅. This however means that some of the lanthanum has however reacted but is less and most of it has formed the oxide. However the experiment was repeated and this time the results showed that the intensities were less in all the compounds present (LaNi₅, La₂O₃ and nickel) but the most important observation was the fact that the material was ‘softer’ compared to the first metallic sample after arc melting. The changes to the repeat sample was not that much different but the handling of the sample was done more carefully and the lanthanum was added as pieces at the arc melting stage. Also the amount of melts was reduced to maximum of three and after the second melt the sample was removed and analyzed and found to be ‘softer’. This could therefore mean that reducing the melts and preparing the lanthanum after (not during the pellet producing stage) could have a slight difference in producing the LaNi₅. Also a slight excess of initial lanthanum was added to the repeat sample which was not the case in the first test (in the first test the calculated exact amount of lanthanum was added) see Appendix A for calculations of lanthanum. This could mean that an excess of lanthanum could compensate for the formation of oxide and favor the formation of LaNi₅. The slag of this material also shows traces of LaNi₅ although much less but has high intensities of nickel which means that there is still room for improvements. Another observation made as that when less initial sample was used the effect was better as the lanthanum had come into closer contact with the nickel and seemed to react better when comparing the XRD patterns of the samples with less material than the samples with initially more weight. This could also relate to the dynamics of the arc furnace where less material seems to perform better than more.

1. A method of producing a nickel-containing hydrogen storage alloy for use in a nickel metal hydride battery, the method comprising:
i. providing a mixed active material including used positive electrode active material and used negative electrode active material;
ii. reducing the mixed active material, thereby obtaining a reduced active material;
iii. adding one or more metals to the reduced active material to obtain a mixture;
iv. melting the mixture; and
v. cooling the melt, thereby obtaining a nickel-containing hydrogen storage alloy.

2. The method according to claim 1, wherein the used positive electrode active material includes nickel oxyhydroxide and the used negative electrode active material includes an AB₅ alloy, wherein A is mischmetal, La, Ce or Ti, and B is Ni, Co, Mn or Al.

3. The method according to claim 1, wherein the nickel-containing hydrogen storage alloy is AB₅, wherein A is mischmetal, La, Ce or Ti, and B is Ni, Co, Mn or Al.

4. The method according to claim 1, wherein the one or more metals in step iii are chosen from mischmetal, La, Al, virgin AB₅ alloy, or mixtures thereof.

5. The method according to claim 4, wherein the mischmetal or La are added in quantities sufficient to recreate the elemental ratio of an AB₅ alloy.

6. The method according to claim 1, wherein the reduction in step ii is performed under a hydrogen atmosphere of about 700 mBar.

7. The method according to claim 1, wherein the reduction in step ii is performed at a temperature of about 200° C. to about 500° C.

8. The method according to claim 1, wherein a product of step ii and/or step iii is stored under inert atmosphere prior to further use.

9. The method according to claim 1, comprising a step of removing electrode support materials and washing the used positive and the used negative electrode active materials prior to step i.

10. The method according to claim 1, wherein slag is removed from the melt in step iv.

11. The method according to claim 1, wherein melting in step iv is performed at 900-1100° C.

12. The method according to claim 1, wherein in step v, the melt is cooled over at least 10 hours.

13. A nickel-containing hydrogen storage alloy for use in nickel metal-hydride batteries, obtained by the method of claim 1.

14. The nickel-containing hydrogen storage alloy according to claim 13, wherein the nickel-containing hydrogen storage alloy is an AB₅ alloy; and
wherein A is mischmetal, La, Ce or Ti, and B is Ni, Co, Mn or Al.

15. A nickel-containing hydrogen storage alloy comprising nickel obtained from used positive electrode active material.
